(19) United States
(12) Patent Application Publication
(10) Pub. No.: US 2007/0289688 A1
(43) Pub. Date: Dec. 20, 2007

(54) PROCESSES FOR PRECUTTING LAMINATED FLOCKED ARTICLES

(75) Inventor: Louis Brown Abrams, Fort Collins, CO (US)

Correspondence Address: SHERIDAN ROSS PC, 1560 BROADWAY, SUITE 1200, DENVER, CO, 80202, US

(73) Assignee: HIGH VOLTAGE GRAPHICS, INC., Fort Collins, CO (US)

(21) Appl. No.: 11/849,840

(22) Filed: Sep. 4, 2007

Related U.S. Application Data
(63) Continuation-in-part of application No. 10/961,821, filed on Oct. 7, 2004, now abandoned.
(63) Continuation-in-part of application No. 09/735,721, filed on Dec. 13, 2000.
Application No. 09/735,721 is a continuation-in-part of application No. 09/621,830, filed on Jul. 24, 2000.
(63) Continuation-in-part of application No. 09/621,830, filed on Jul. 24, 2000.
(60) Provisional application No. 60/509,834, filed on Oct. 8, 2003.

(51) Int. Cl. B29C 65/02; B32B 33/00

(52) U.S. Cl. 156/72; 428/90

(57) ABSTRACT

A process for forming a flocked article is provided that includes the steps of: (a) cutting a pre-formed or solid adhesive film into a desired shape; (b) removing a first portion of the cut pre-formed adhesive film from a second portion of the cut pre-formed adhesive film; and (c) heating and applying pressure to the cut pre-formed adhesive film to adhere the film to flock to form a flocked article.

### CROSS REFERENCE TO RELATED APPLICATIONS

The present application is a continuation-in-part of U.S. patent applications having (a) Ser. No. 10/961,821, filed Oct. 7, 2004, which claims the benefits of U.S. Provisional Application Ser. No. 60/509,834, filed Oct. 8, 2003, entitled “Process for Forming Flocked Articles”; and (b) Ser. No. 09/735,721, filed Dec. 13, 2000, which is a continuation-in-part of U.S. application Ser. No. 09/621,830; and (c) Ser. No. 09/621,830, filed Jul. 24, 2000, each of which is incorporated herein by this reference.

### FIELD OF THE INVENTION

The present invention is directed generally to decorative articles and specifically to flocked articles.

### BACKGROUND

Flocked decorative articles are gaining in popularity. Flocking involves applying short monofilament fibers, usually nylon or rayon, directly onto a substrate that has been previously coated with an adhesive. The diameter of the individual flock strand is only a few thousandths of a centimeter and ranges in length from about 0.25 to about 5 mm. Decorative flocking is accompanied by using one of four application methods, electrostatic, beater bar/gravity, spraying, and transfers.

In one process configuration, a flock transfer, which includes a sacrificial carrier sheet adhered by a release adhesive to flock is laminated to a pre-formed adhesive film, such as a thermoplastic or thermoset film. The laminate is cut to provide the finished design.

When cutting is performed after lamination, it has been discovered that the final product can have flaws. In such applications, the final design image must be cut from the laminated film by cleanly cutting through the adhesive film layer, with the unwanted portion to be discarded being “weeded” out or peeled away for removal and discard. For very fine and delicate designs, such as a 12-point font lettering it is impractical at best, impossible at worst, to make cutting dies so other cutting methods like laser cutting are preferred.

In one type of laser cutter, the laser head does not move around to locate itself directly over the cut. Instead, the laser head is in a fixed position at the side of the cutting machine. From this position, the head projects the laser beam onto a mirror in the center of the cut area. The mirror is also fixed but swivels to focus the beam at the desired location. The farther the mirror is away from the center of the cut area; the more of an angle that the laser beam is working at. The challenge is to focus the laser precisely on the film layer, which becomes even more serious if the laser beam is cutting further away from the mirror. This results in a more extreme angle such that any inaccuracy in laser focus causes the laser to either not cut far enough into the film or cut too far and past the film, such as into the flock fiber layer. The long thickness of material cut is limited or angled by this type of laser cutter, which is the fastest type known.

Other problems with laser cutters include not only the inconsistency of the clean cut (e.g., little strings remain making removal of the part to be weeded out very difficult to do) but also jagged or wavy edges. While not wishing to be bound by any theory, it is believed that the inconsistency is the result of a slightly uneven fiber surface and/or the flowing of the adhesive film onto and into the flock fibers adjacent to the cut.

### SUMMARY OF THE INVENTION

These and other needs are addressed by the various embodiments and configurations of the present invention. The present invention is directed generally to pre-cut adhesive film(s) for flocked graphics, both by direct flocking and transfer flocking techniques.

In one embodiment, the present invention is directed to a process in which flock is laminated to an adhesive film to adhere permanently the adhesive to the flock. The adhesive film and/or a transfer comprising the flock are cut before lamination. The unwanted portions of the cut adhesive film and/or transfer are removed from the wanted portions before lamination is performed.

In one embodiment, the adhesive film includes an adhesive layer attached to a release sheet and the adhesive layer, and/or the release sheet, is cut through prior to lamination. The wanted portion of the adhesive layer remains on the release sheet while the unwanted portion is removed from the release sheet and discarded. A flocked release sheet is then contacted with the wanted portion, and the flock fibers are laminated to the wanted portion of the adhesive layer. Flock fibers adjacent to the portion(s) of the release sheet, from which unwanted portion(s) of the adhesive layer have already been removed, are removed, after lamination, with the flock carrier sheet.

The positioning of cutting and weeding operations before heating/activating (full or partial) of the adhesive film can have numerous benefits. By performing cutting before lamination, the transfer is cut before the transfer sheet is attached to the flock. By cutting on a relatively smooth, flat and fine gauge release sheet or the adhesive film itself, adjustment of the cutting device cut can be precise, much faster, and without influence from the fiber layer. The unwanted portion to be discarded can be peeled away easily and disposed of before lamination.

These and other advantages will be apparent from the disclosure of the invention(s) contained herein.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 shows a process configuration according to a first embodiment of the present invention;

FIG. 2 is a side view of contacted films in the process configuration of FIG. 1;

FIG. 3 is a side view of a flocked film in the process configuration of FIG. 1;

FIG. 4 is a side view of a product in the process configuration of FIG. 1;

FIG. 5 shows a process configuration according to a second embodiment of the present invention;

FIG. 6 is a plan view of a composite film in the process configuration of FIG. 5;

FIG. 7 is a plan view of a cut composite film in the process configuration of FIG. 5;

FIG. 8 is a side view of a film product in the process configuration of FIG. 5;

FIG. 9 shows a process configuration according to a third embodiment of the present invention;

FIG. 10 is a plan view of a cut adhesive film in the process configuration of FIG. 9;

FIG. 11 is a plan view of a flock transfer positioned on top of the cut adhesive film of FIG. 10;

FIG. 12 is a plan view of a laminated film product in the process configuration of FIG. 9;

FIG. 13 is a side view of a laminated film product in the process configuration of FIG. 9;

FIG. 14 shows a process configuration according to a fourth embodiment of the present invention;

FIG. 15 is a plan view of a cut and unweeded adhesive film in the process configuration of FIG. 14;

FIG. 16 is a plan view of a cut and weeded adhesive film in the process configuration of FIG. 14;

FIG. 17 is a side view of an adhesive film in the process configuration of FIG. 14;

FIG. 18 is a side view of a laminated film product in the process configuration of FIG. 14;

FIG. 19 is a side view of a flocked design in the process configuration of FIG. 14; and

FIG. 20 is a side view of a flocked release sheet in contact with a cut and weeded adhesive film.

### DETAILED DESCRIPTION

### Direct Flocking Process

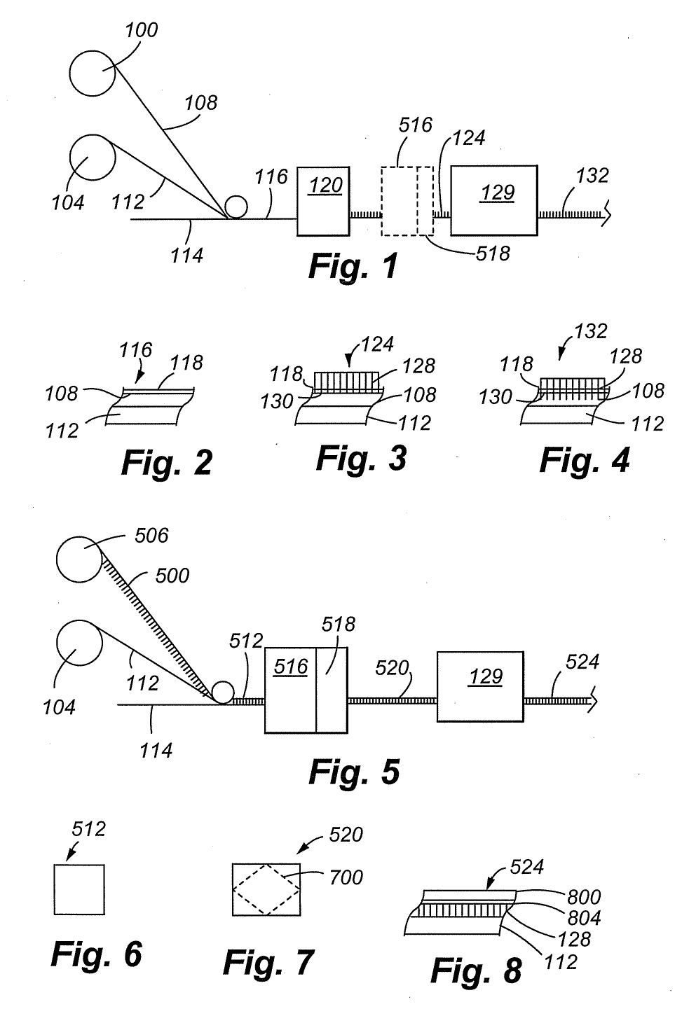

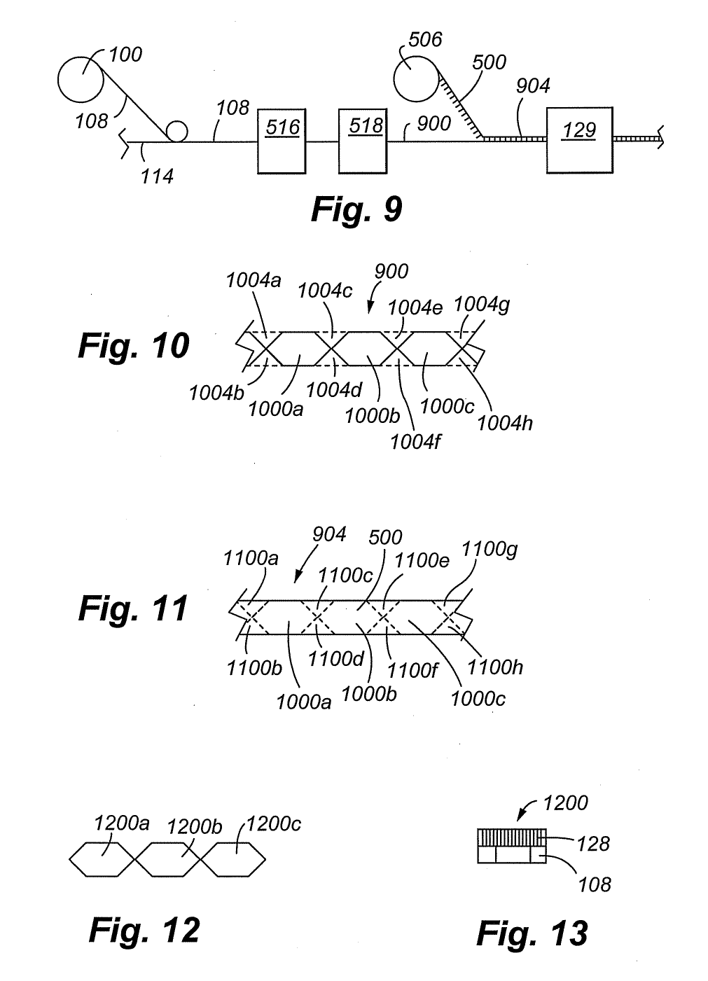

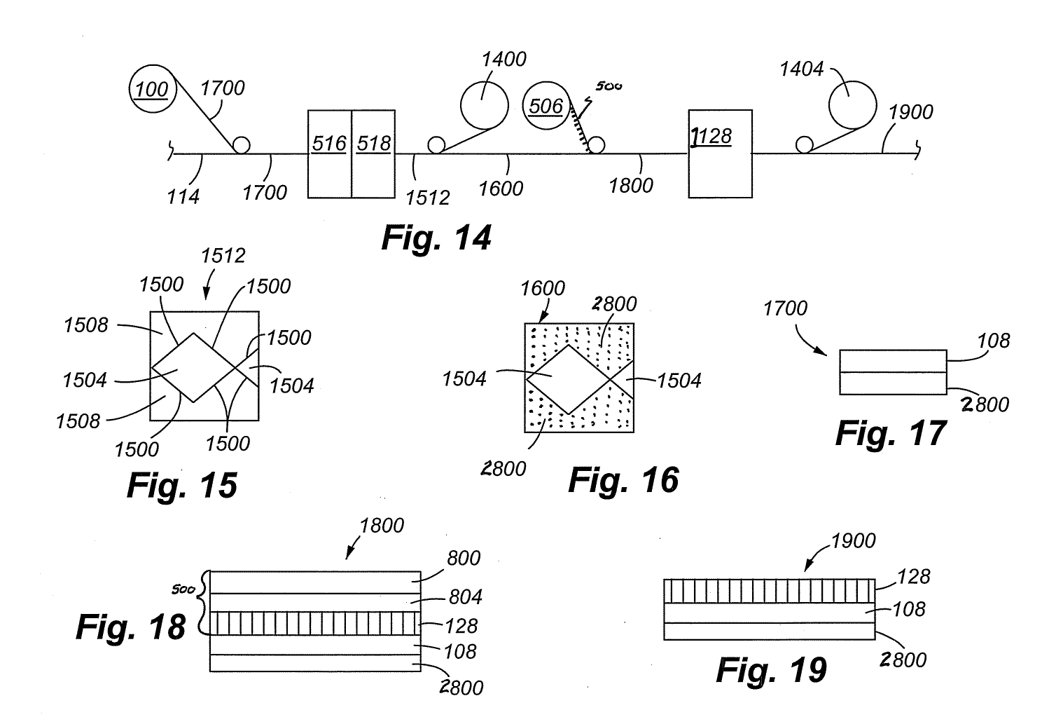

Referring to FIGS. 1-5, a system for manufacturing a flocked article according to a first embodiment of the present invention is depicted. The system includes a first roll 100 containing a permanent (pre-formed) adhesive film 108 and a second roll 104 containing a substrate film 112. The second roll 104 and substrate film 112 is omitted in certain applications. The pre-formed films 108 and/or 112 are contacted one on top of the other on a continuous running web line 114.

The adhesive film 108 can be any suitable adhesive film for the application. As will be appreciated, an “adhesive” is any substance, whether inorganic or organic, natural or synthetic, that is capable of bonding other substances together, typically by surface attachment. Examples of suitable adhesives include high temperature adhesives, such as polybenzimidazoles and silica-boric acid mixtures or cermets, hot-melt adhesives, thermoset adhesives, thermoplastic adhesives, and polyurethane. “Hot-melt adhesives” generally refer to a solid material that forms a mechanical or melt bond upon heating and subsequent cooling, “thermoset adhesives” generally refer to a polymer that solidifies or “sets” irreversibly when heated, and “thermoplastic” generally refer to a polymer that softens when heated and resolidifies when cooled to room temperature. The irreversible setting of the adhesive is effected by cross-linking of at least most, if not all, of the polymers in the adhesive. The adhesive film can include fine particles of polymers or copolymers, as well as one or more of plasticizer(s), stabilizer(s), curing agent(s) (such as an isocyanate), pigment(s), etc. The pigment, if any, determines the color and opacity of the adhesive film. The stabilizer, used when pigment is added, prevents discoloration of the resin film. Thermoset adhesives can include curing agents such as organic peroxides or sulfur. Examples of thermosetting adhesives include polyethylene, polyurethanes, polyamides, phenolics, alkyds, amino resins, polyesters, epoxides, and silicones.

The adhesive film 108 is preferably pre-formed before contact with the flock. As will be appreciated, pre-formed adhesive films can be formed by any number of processes, including solvent casting and extrusion. The adhesive film can be one or a combination of the above-types of adhesive layers. For example, the adhesive film may be a combination of two or more of thermoplastic, thermosetting, and/or pressure sensitive adhesive layers. In one configuration, the adhesive film includes only a thermosetting adhesive. In another configuration, the thermosetting adhesive useful for a sticker includes an approximately 1 mil thermosetting polyurethane liner with a pressure sensitive adhesive. The various layers are preferably adhered to one another, such as by laminating techniques, prior to cutting so that the cutting device is able to cut through all of the layers simultaneously.

The substrate film 112 can be any desired film, whether adhesive or nonadhesive. In a preferred configuration, the film 112 is a formable thermoplastic material having a softening point that is at or near the maximum temperature experienced by the substrate film 112 in later processing steps, such as molding. In molding, the maximum temperature is typically less than the melting point and maximum temperature of the resin to provide a melt bond and tensile and compressive strengths and thermal stability sufficient to withstand the maximum pressures experienced in the closed mold without warping or shrinking. The softening point of the substrate film is typically slightly lower than the maximum temperature realized by the resin and substrate film during molding. As will be appreciated, it is important that the resin be chemically and physically (e.g., thermally) compatible with the substrate film to produce a strong melt bond between materials and thus an integral article after removal from the closed mold. Preferably, the substrate film is a polymeric material and the polymers in the substrate film melt bond with the polymers in the resin. Exemplary backing films include monomers, oligomers, or polymers (which term includes copolymers, terpolymers, etc.) of styrene, acrylics, vinyls, olefins, cellulosics, carbonates, urethanes, amides, ethylenes, carbonates, propylenes, and esters, acrylic butyl styrene (ABS), and mixtures thereof. A particularly preferred substrate film for many resins is a polycarbonate. Thus, the film is able to withstand high pressure and high temperature without degrading, cracking, or melting. In another configuration, the substrate 112 is a carrier sheet with or without a release adhesive between the carrier sheet and adhesive film.

The substrate film is preferably nonwoven and neither a textile nor a fabric. Preferably, the substrate film, like the adhesive film, is in the form of a cast or extruded continuous film. Woven textiles and fabrics can resist stretching or form wrinkles when trying to form into a three-dimensional or nonplanar shape due to the weave of the material.

The contacted films 108 and 112 are subjected to flocking in a flocking device 120 to form a flocked film 124. The flock is held in position on the adhesive film by a binder adhesive 118. The flock fibers 128 can be formed from any natural or synthetic material. Synthetic material includes rayons, nylons, polyamides, polyesters such as terephthalate polymers and acrylic, and natural material includes cotton and wool. In one configuration, a conductive coating or finish is applied continuously or discontinuously over the exterior surface of the flock fibers to permit the flock fibers to hold or attract moisture (water content) and thus an electrical charge.

The conductively coated flock is applied by electrostatic flocking techniques such as described in U.S. Pat. Nos. 4,810,549; 5,207,851; 5,047,103; 5,346,746; 5,597,637; 5,858,156; 6,010,764; 6,083,332; and 6,110,560 and in copending U.S. patent application Ser. Nos. 09/548,839; 09/621,830; 09/629,746; and 09/735,721, each of which is incorporated herein by this reference. The flock is electrostatically charged (while the combined films 116 are given the opposite electrical charge or have neutral polarity by grounding).

Electrostatic flocking causes typically at least most, and even more typically at least about 65%, of the individual flock fibers to be oriented transverse to and typically perpendicular to the planes of the substrate surface (in direct flocking). Compared to woven textiles, this non-woven fiber alignment forms a desirable dense pile finish.

Preferably at least most, and even more preferably at least about 75%, and even more preferably all, of the flock fibers have a preferred denier of no more than about 60, more preferably no more than about 25, and even more preferably no more than about 5, with a range of from about 1.5 to about 3.5 being typical and have a titre ranging from about 0.5 to about 20 Dtex (from about 0.5 to about 20×10⁻⁷ Kg/m) and even more preferably from about 0.9 Dtex to about 6 Dtex. The length of at least most, and typically at least about 75%, of the fibers is preferably no more than about 4 mm, more preferably no more than about 2 mm, and even more preferably no more than about 1 mm, with a range of from about 0.3 to about 3.5 mm being typical. The fiber placement density relative to the surface area of the upper surface 1116 of the substrate (on which the flock is deposited) is preferably about 50% fibers/in², even more preferably at least about 60% fibers/in², and even more preferably at least about 70% fibers/in² of the surface area of the substrate surface 1116.

In these processes, different colors of flock (or fibers) are typically applied through separate screens or a single color flock is applied and later sublimation printed to form the multi-colored design. In multi-color flocking, the screens have a distribution of openings consistent with the desired locations of the respective colors of flock fibers. Other techniques, which can mount the flock in a desired position and in such a way as to hold or entrap the flock after curing, can also be employed in either the direct or transfer flocking process configurations. Such techniques include vibration, gravity, and spraying of the flock onto the adhesive-coated surface.

Cutting and weeding devices 516 and 518 are located between the flocking device 120 and heating and/or pressurizing device 129 in the process of FIG. 1. The cutting device 516 cuts the flocked surface 124 into desired shapes as discussed below while the weeding device 518 peels off or removes the unwanted portions of the flocked surface 124 before lamination. The cutting device can be a suitable cutting device, such as a steel-rule die, hard tool metal die, laser cutter, ultrasound cutter, high frequency cutter, or water jet cutter.

In one alternative embodiment, the films 108 and 112 are cut before flocking occurs. In other words, the cutting and weeding devices 516 and 518 are positioned between the rolls 100 and 104 and the flocking device 120 so that cutting and weeding occurs before the flock is in (intimate) contact with the film 108. This avoids problems from adhesive films flowing down the flock fibers and unevenly cut films (because of the uneven nature of a flocked coating). In this embodiment, a direct flock (second) adhesive could be applied, such as by spraying, to adhesive film 108 in register to the cut film pieces, possibly with an overlap around at least a portion of, and commonly all the way around, the cut adhesive film piece. Alternatively, the film 108 could be heated until it is sticky or tacky enough to adhere to the flock fibers and then direct flocked while held or maintained at temperature.

The flocked surface 124 is next treated by the heating and/or pressurizing device 129, such as a lamination machine, to produce a flocked product 132. The heating device heats the adhesive film 108 to a temperature above the softening point of the adhesive while the pressuring device applies pressure on the free ends of the flock fibers and forces the fibers into the softened adhesive film. As can be seen from FIG. 4, the flocked product 132 has the flock fibers 128 extending into the adhesive film 108 and passing through the upper surface 130 of the adhesive film 108. The softening and pressuring operations also cause the adhesive film 108 to adhere to the substrate film 112.

Preferably, the flocked surface is heated to a temperature below the melting point and full activation temperature of the adhesive film 108. In other words, the adhesive film 108 in the product 132 is typically not fully cross-linked. The adhesive film 108 is typically fully cross-linked in a later process step, particularly when the substrate film 112 is omitted. However, in certain applications, the adhesive film 108, during lamination, may be heated to a temperature to fully activate and cross-link the adhesive film.

### Transfer Flocking Process

The second embodiment of the present invention will now be discussed with reference to FIGS. 5-8.

As in the prior embodiment, the system includes first and second rolls 506 and 104. The first roll contains a flocked transfer sheet 500 and the second roll the adhesive film 112. The flocked transfer sheet 500 includes a release sheet 800 and release adhesive 804.

The release sheet 800 can be any suitable transfer carrier that is formable and dimensionally stable with the flock. Examples of other types of suitable transfer carriers include plastic films. The sheet is preferably a discontinuous sheet or a running web line material. The carrier sheet or film has been found to assist in robotically feeding the mold insert or mold insert film into the forming tool and/or the mold itself. A vacuum is able to pick up the mold insert or mold insert film and transport and position the insert at a desired location in the forming tool/open mold. Other techniques to establish a vacuum connection include (i) the use of a discontinuous release sheet, where the release sheet is positioned to contact the vacuum suction cups but not in other adjacent areas where flock is exposed due to an absence of an overlying release sheet, and (ii) the use of a discontinuously applied or located flock surface, where no flock fiber is deposited in first region(s) to provide an exposed permanent adhesive or backing film in the first region(s) to contact the suction cups from the flocked side of the insert. Flock is deposited in one or more adjacent second region(s) where no vacuum suction cup is positioned.

The release adhesive 804 is formulated such that the bonding force between the release adhesive 804 and the flock 128 is less than the bonding force between the adhesive 112 and flock 128. In this manner, the sheet and release adhesive can be removed after lamination of the transfer without causing separation of the flock from the adhesive film. Preferably, the melting point of the release adhesive is greater than the maximum temperature realized by the injected resin in the mold (and the melting point of the resin) and more preferably greater than the maximum temperature realized by the release adhesive during molding. As will be appreciated, for a cooled mold it is possible that the melting point of the release adhesive may be slightly less than the resin temperature.

The adhesive film and transfer 500 are contact one on top of the other to form a composite film 512. In the composite film 512, the adhesive film 112 is generally not adhered to bonded to the lower free ends of the flock 128.

The composite film 512 is subjected to cutting in a suitable cutting device 516. The film 512 (including both the transfer 500 and adhesive film 112) is cut into desired shapes, such as the diamond represented by cut lines 700 in FIG. 7. The cut takes place while the flock is still mounted on the release sheet. For laser cutting, the laser can be configured to cut to a precise depth or kiss cut so that it will not cut the web 114.

The cut film is next weeded by the weeding device 518. Unwanted portions, such as the film 512 portions located exteriorly of the diamond or cut lines 700, are removed prior to lamination. In other words, the diamond 700, but not the unwanted portions, remains on the web 114 for input into the heating and/or pressurizing device 129.

The cut and weeded composite film 520 is next heated and pressurized in the heating and/or pressurizing device 129 to form a film product 524.

FIG. 9 depicts a process embodiment according to yet another embodiment of the present invention. The process includes a first roll 100 of the adhesive film 108, which is fed onto a continuous web 108. The adhesive film 116 is cut into desired shapes by the cutting device 516 and the unwanted portions removed from the web 114 by the weeding device 518.

FIG. 10 depicts the cut and weeded adhesive film 900. The cut and weeded film 900 includes a plurality of identically shaped repeating adhesive film segments 1000a-c. The adhesive film portions 1004a-h (the areas bounded by the dashed lines and peripheral lines of the film segments) positioned between the adjacent segments have been removed by the weeding device 518.

The cut and weeded film 900 is next contacted with the transfer 500 to form a composite film 904 before lamination occurs. FIG. 11 shows the transfer 500 positioned on top of the adhesive film segments 1000a-c (shown by dashed lines). As will be appreciated, the portions of the transfer 500 above the weeded out areas 1100a-h have no adhesive to adhere to. Thus, after lamination removal of the release sheet removes the flock in these areas as well (because the flock stays attached to the carrier sheet).

As can be seen in FIG. 11, the various adhesive film segments 1000a-c are interconnected by a thin part of continuous material peripherally running down the center of the material and the cut scrap material or weeded out areas 1100a-h may be interconnected by a thin part of continuous scrap material along at least one side of the portion of the cut material web to be discarded. In this way, a rewind mechanism can be used in the line (also called take-up reel) and when production begins the finished product and/or scrap material may be attached to the rewind wheel. The wheel or roll collects the material. In the case of weeding unwanted scrap material, the wheel or roll automatically removes the scrap material from the web before the scrap material is contacted with the flock fibers.

The laminator 1128 causes the adhesive film 900 to adhere to the overlying flock fibers in the transfer 500 to form a laminated film product 908. Removal of the release sheet produces a plurality of flocked articles 1200a-c shown in FIGS. 12 and 13. Each flock article 1200 includes a plurality of flock fibers 128 adhered to an underlying adhesive film 108.

The process of this embodiment is commonly preferred. The film combination can be quickly, precisely, and cleanly cut and weeded before being combined to flock-with-release-adhesive on another carrier substrate. During heat lamination and activation of thermoset films, for example, flock will only transfer where it is in contact with the precut thermoset film, and the peripheral flock fibers can do a nicer job of covering the edges than is possible with application of flock fibers before cutting of the adhesive film is performed. In the latter case, “raw” cut edges can be seen and sometimes have a white adhesive appearance visible from the side that looks unfinished and therefore of lower perceived value to consumers.

In another configuration, the transfer 500 can be precut and weeded using different cutting and weeding devices and located on top of the corresponding film segment 900 before lamination occurs. As will be appreciated, when a multicolor flocked design on the transfer 500 is being laminated to a pre-cut film it can be done in register. In other words, the cut film is aligned using known techniques with the corresponding flocked design.

Another process embodiment will now be discussed with reference to FIGS. 14-18.

The first roll 100 contains a permanent adhesive film 1700 shown in FIG. 17. The adhesive film 1700 includes a release or carrier sheet 2800 and the adhesive layer 108. The adhesive film 1700 is preferably self-supporting and formed by any suitable technique, such as lamination or solvent casting. In solvent casting, the liquefied adhesive is applied to the release sheet followed by curing to remove the solvent. This leaves the solidified adhesive supported by the release sheet. After the adhesive is applied to a desired surface, such as a free surface of the flock fibers 128, the release sheet 2800 is removed to expose the lower surface of the adhesive layer 108 for permanent attachment to a selected substrate.

The first roll 100 provides the adhesive film 1700 to the moving web 114.

The adhesive layer 108, while on the moving web and on the release sheet 2800, is cut to a desired shape by cutting device 516 to form a cut and unweeded adhesive film 1512. As noted, cutting device 516 is typically a die cutting device or laser cutter. FIG. 15 shows the cut lines 1500 in the adhesive layer 108. The cut lines 1500 define wanted and unwanted portions 1504 and 1508, respectively, of the adhesive layer 108. The cut lines 1500 typically pass through the adhesive layer 108 but not through the release sheet 2800.

In one configuration, the cut lines pass through the lower release sheet 2800. In this configuration, the unwanted adhesive portions 1504 and attached, cut release sheet 2800 fall automatically from the continuous web down onto a conveyer belt or directly into a bin, eliminating the need to hand-weed the unwanted portions from the wanted portions. This configuration is used for cutting devices, other than optical cutters such as lasers, that do not permit precise control of cut depth. Examples of such devices include mechanical cutters.

The weeding device 518 causes the unwanted portions 1504, which are interconnected on either side of the wanted portions 1504, to be separated from the wanted portions 1504 and collected on a third roll 1400. FIG. 16 shows the weeded adhesive film 1600. In the weeded adhesive film 1600, the wanted portions 1504 remain attached to the release sheet 2800 after removal of the unwanted portions 1508. The release sheet 2800 is exposed in respective areas by removal of the unwanted portions 1508.

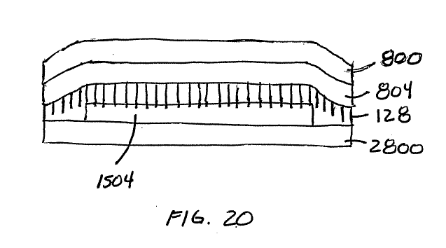

A second roll 506 provides a flocked release sheet 500. The flocked release sheet includes flock fibers 128 attached to a release or carrier sheet 800 by a release adhesive 804. The release sheet 800 is preferably a microporous film. FIG. 18 shows the assembly 1800. The assembly 1800 includes the upper and lower release sheets 800, 2800 release adhesive 804, flock fibers 128, and wanted portion(s) of the adhesive layer 108. Where the unwanted portions have been removed, the flock fibers 128 are not in contact with the adhesive layer 108 and, as shown in FIG. 20, instead may be in direct contact with the release sheet 2800.

The assembly 1800 then passes through the lamination device 1128, which applies heat and pressure to cause the flock to adhere to and/or cure the remaining adhesive layer 108. Where the unwanted portions of the adhesive layer have been removed, the flock will not adhere to the adhesive layer and attached lower release sheet 2800.

The fourth rewind roll 1404 collects the upper release sheet 800, release adhesive 804, and unattached flock fibers 128. The unattached flock fibers 128 refer to the flock fibers that did not adhere to the wanted portion(s) of the adhesive layer 108, or that are located where the unwanted portion(s) have been removed. As can be seen in FIG. 19, the flocked design 1900 includes flock fibers 128 embedded in and adhered to the wanted portion of the adhesive layer 108, which is in turn adhered to the lower release sheet 2800. The shape of the wanted portions of the adhesive layer 108 is in the final desired shape for the design. To attach the design 1900 to a desired substrate, the lower release sheet 2800 is removed and the exposed surface of the adhesive layer 108 attached, is applied under heat and pressure, to the desired substrate (not shown). The desired substrate can be, for example, a textile or substrate film 112.

In one implementation, the fourth rewind roll 1404 collects only the release sheet 800 and attached release adhesive 804, leaving the flock 128, adhesive film 1504, and release sheet 2800 on the moving web. A further cutting step is performed, typically completely through the carrier sheet 2800, to the flock, film, and sheet to form features of a desired graphical design. For example, certain designs have disconnected design elements, like the letters in “FORD”. The letter outlines and/or only interior void spaces of the letters are cut by the second cutting device. Typically, the letter outlines are cut in the pre-cutting step and the interiors of the letters in the second or post-lamination cutting step. A second release sheet and release adhesive are then contacted with the flock fibers. The unwanted flock 128, adhesive film 1504, and release sheet 2800 segments are then adhered to the release sheet. The second release sheet is then collected on a further rewind roll (not shown) to remove and weed automatically the unwanted flock 128, adhesive film 1504, and release sheet 2800 segments.

The techniques of the present invention can be used in any process for manufacturing decorative objects. For example, the techniques can be used in the manufacture of heat transfers, direct flocked articles, molded flocked articles, and the like, such as disclosed in the following patents/patent applications: U.S. Provisional Application Ser. Nos. 60/422,206, filed Oct. 29, 2002; 60/393,362, filed Jul. 3, 2002; 60/416,098, filed Oct. 4, 2002; 60/403,992, filed Aug. 16, 2002; 60/405,473, filed Aug. 23, 2002; 60/366,580, filed Mar. 21, 2002; 60/327,642, filed Oct. 5, 2001, 60/344,862, filed Nov. 8, 2001, and 60/332,647, filed Nov. 21, 2001; and 60/393,362, filed Jul. 3, 2002; U.S. Pat. Nos. 4,810,549; 5,047,103; 5,207,851; 5,346,746; 5,597,637; 5,858,156; 6,010,764; 6,083,332; 6,110,560; U.S. patent application Ser. Nos. 10/265,206, filed Oct. 5, 2002; 09/629,746, filed Jul. 31, 2000; 09/735,721 filed Dec. 13, 2000; 09/621,830 filed Jul. 24, 2000; 29/058,551 filed Aug. 19, 1996; 09/548,839 filed Apr. 13, 2000; and 09/973,113 filed Oct. 9, 2001, each of which is incorporated herein by this reference.

In the embodiment of FIGS. 9-10, the release adhesive 804 can be selectively applied to the release sheet 800 only in locations where flock is needed (such as in the areas of the transfer 500 in contact with the adhesive segments 1000a-c), leaving the rest of the release sheet 800 blank or free of release adhesive (such as in the areas of the transfer 500 adjacent to the weeded our areas 1100a-c). In this manner, the flock will be applied only to the sections of the release sheet 800 contacting the release adhesive 804 with no flock being located in the sections of the release sheet 800 which are free of the release adhesive 804. The flock is thus applied only where needed, thereby saving material. As will be appreciated, the release adhesive is generally applied to those sections of the release sheet 800 overlying the adhesive film segments 1000a-c. In one configuration, the release adhesive is applied not only over the area of the release sheet 800 in contact with the adhesive film segments 1000a-c but also outside this area to avoid quality problems resulting from misregistration of the flocked area of the release sheet and the adhesive film segment.

In another embodiment, the performing of cutting before laminating is done in a process in which (a) a hotmelt film is contacted with a carrier, (b) the film is coated with adhesive and flock to form a flocked article, and finally (c) the flocked article cold laminated to a pressure sensitive adhesive to form a “sticker” on a carrier. Cutting is performed after step (a) and before steps (b) and (c).

A number of variations and modifications of the invention can be used. It would be possible to provide for some features of the invention without providing others.

For example in one alternative embodiment, the process of the second embodiment is not limited to transfers. As will be appreciated, instead of a transfer 500 the process may be used with direct flocking. In that event and with reference to FIG. 1, the laser cutting device 516 is positioned between the flocking device 120 and the heating/pressurizing device 1128.

In another alternative embodiment, the positions of the first roll 506 and the second roll 104 are reversed such that the release sheet 800 is positioned on the bottom (in contact with the running web line 114) and the adhesive film 104 on top. In other words, the film 512 is flipped upside down relative to the position depicted in FIGS. 5-8. The positioning of the release sheet 800 on the bottom can provide cleaner cuts and prevent cutting of the web line 114 by the cutting device 516.

In yet another embodiment, the laminating station can be any suitable device or devices for heating and softening the adhesive film and embedding the flock fibers in the film. In one configuration, the station is a clam shell-type device, for example.

In yet another embodiment, the cutting station is a device other than an optical (laser) cutter. It can, for example, be a mechanical cutter, such as a kiss cutter, a saw or knife blade, and the like.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A process for forming a flocked article, comprising:
cutting a preformed, solid adhesive film into a desired shape;
contacting flock with the cut adhesive film; and
while the flock is in contact with the cut adhesive film, heating and applying pressure to the adhesive film to soften the adhesive film and embed ends of the flock in the adhesive film, thereby adhering the adhesive film to the flock.

2. The process of claim 1, wherein, in the heating step, the adhesive film is not melted fully and wherein the flock is in the form of a transfer and engages a release adhesive deposited on a carrier sheet and wherein, in the cutting step, the transfer is in contact with and cut simultaneously with the adhesive film.

3. The process of claim 1, wherein, in the heating step, the adhesive film is free of melting, wherein the adhesive film comprises an adhesive layer and a release sheet, and wherein, in the cutting step, the cut passes through the adhesive film but not the release sheet.

4. The process of claim 3, further comprising:
after the cutting step and before the heating step, removing an unwanted portion of the adhesive layer from a wanted portion of the adhesive layer and from the release sheet.

5. The process of claim 4, wherein the flock is in the form of a transfer and engages a release adhesive deposited on a carrier sheet and wherein the contacting step follows the cutting step and precedes the heating step.

6. The process of claim 5, wherein the transfer is not cut to the desired shape in the cutting step.

7. The process of claim 6, wherein, after the laminating step, the carrier sheet is removed from a first portion of the flock, the at least a portion of the flock being adhered to the wanted portion of the adhesive layer, but not a second portion of the flock, the second portion of the flock being adjacent to a portion of the release sheet exposed by removal of the unwanted portion of the adhesive layer therefrom.

8. The process of claim 7, wherein flock in the areas where the unwanted cut adhesive film has been removed is removed with the carrier sheet.

9. A flocked article manufactured by the process of claim 1.

10. A process for forming a flocked article, comprising:
(a) cutting a solid adhesive film into a desired shape;
(b) removing a first portion of the cut solid adhesive film from a second portion of the cut solid adhesive film;
(c) contacting a flocked carrier sheet with the cut solid adhesive film, the flocked carrier sheet comprising flock adhered to a carrier sheet by a release adhesive, wherein the flock is in contact with the cut solid adhesive film; and
(d) while the flock is in contact with the cut solid adhesive film, heating and applying pressure to the adhesive film to soften the adhesive film and embed ends of the flock in the adhesive film, thereby adhering the adhesive film to the flock.

11. The process of claim 10, wherein, in the heating step, the adhesive film is not melted fully and wherein, in the cutting step, the flocked carrier sheet is in contact with and cut simultaneously with the adhesive film.

12. The process of claim 10, wherein, in the heating step, the adhesive film is free of melting, wherein the adhesive film comprises an adhesive layer and a release sheet, wherein, in the cutting step, the cut passes through the adhesive film but not the release sheet, and wherein the first portion of the cut adhesive film is removed from the release sheet in the removing step (b).

13. The process of claim 12, wherein the flock is first contacted with the second portion of the adhesive film after the cutting step (a).

14. The process of claim 13, wherein the flocked carrier sheet is not cut to the desired shape in the cutting step.

15. The process of claim 14, wherein, after the heating step (c), the carrier sheet is removed from first a portion of the flock, the at least a portion of the flock being adhered to the second portion of the adhesive layer, but not a second portion of the flock, the second portion of the flock being adjacent to a portion of the release sheet exposed by removal of the first portion of the adhesive layer therefrom.

16. The process of claim 15, wherein flock in the areas where the first portion of the cut adhesive film has been removed is removed with the carrier sheet.

17. A flocked article manufactured by the process of claim 10.

18. A process, comprising:
(a) cutting a solid adhesive film into a desired shape, the cut extending completely through the solid adhesive film and a release sheet engaged with the film;
(b) removing a first portion of the cut adhesive film and attached release sheet from a second portion of the cut adhesive film and attached release sheet;
(c) contacting a flocked carrier sheet with the cut adhesive film, the flocked carrier sheet comprising flock adhered to a carrier sheet by a release adhesive, wherein the flock is in contact with the cut adhesive film; and
(d) while the flock is in contact with the cut adhesive film, heating and applying pressure to the adhesive film to soften the adhesive film and embed ends of the flock in the adhesive film, thereby adhering the adhesive film to the flock.

19. The process of claim 18, wherein, in the heating step (d), the adhesive film is free of melting, wherein the first portion of the cut adhesive film is removed from the release sheet in the removing step (b), and wherein the flock is first contacted with the second portion of the adhesive film after the cutting step (a).

20. The process of claim 18, wherein, after the heating step (d), the carrier sheet is removed from first a portion of the flock, the at least a portion of the flock being adhered to the second portion of the adhesive layer, but not a second portion of the flock, the second portion of the flock being adjacent to the location previously occupied by the first portion of the adhesive film, and wherein flock in the areas where the first portion of the cut adhesive film has been removed is removed with the carrier sheet.
